(19) United States
(12) Patent Application Publication
(10) Pub. No.: US 2015/0234789 A1
(43) Pub. Date: Aug. 20, 2015

(54) CREATING AND PRESENTING MULTIMEDIA BIOGRAPHICAL CONTENT

(71) Applicant: Scott St. Germain, Aston, PA (US)

(72) Inventor: Scott ST. GERMAIN, Aston, PA (US)

(73) Assignee: Scott St. Germain, Aston, PA (US)

(21) Appl. No.: 14/307,541

(22) Filed: Jun. 18, 2014

Related U.S. Application Data
(60) Provisional application No. 61/941,596, filed on Feb. 19, 2014.

(51) Int. Cl. G06F 17/21; G06F 3/0484; G06Q 30/02

(52) U.S. Cl. CPC G06F 17/212; G06Q 30/0207; G06F 3/04847; G06F 3/04842

(57) ABSTRACT

The system thereby allows creation of a higher-quality and more comprehensive presentation than could otherwise be achieved. The system may further provide financial compensation for inclusion of third-party content, which may offset the costs of production.

### CROSS-REFERENCE TO RELATED APPLICATIONS

This application claims priority to U.S. Provisional Patent Application No. 61/941,596 filed Feb. 19, 2014, which is incorporated herein by reference.

### BACKGROUND OF THE INVENTION

It is a common practice during celebratory or memorial events to present photos, videos, or other artifacts relevant to the life of the person or persons being celebrated. Generating a comprehensive and coherent presentation, however, requires time, technical capability, and access to appropriate source data. Particularly in the case of a memorial event, there may be insufficient time or energy to produce a high-quality presentation.

Additionally, many celebratory or memorial presentations contain references to institutions, businesses, or organizations with which the person being celebrated may have been associated. Those entities may have an interest in being presented in a positive light and with high production values during such presentations. They may lack, however, knowledge that the event is even occurring or the ability to provide content even when it is available.

What is needed is a system for creating multimedia biographical presentations that automatically locates content relevant to the person being celebrated and to entities with which the person was affiliated, with the ability for those entities to provide content.

### SUMMARY OF THE INVENTION

The system thereby allows creation of a higher-quality and more comprehensive presentation than could otherwise be achieved. The system may further provide financial compensation for inclusion of third-party content, which may offset the costs of production. The system thereby allows creation of a higher-quality and more comprehensive presentation than could otherwise be achieved. The system may further provide financial compensation for inclusion of third-party content, which may offset the costs of production.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 is a system diagram of a system for creating biographical presentations;

FIG. 2 is a flowchart of an exemplary high-level process for selecting content for use in creating a biographical presentation using the system of FIG. 1;

FIG. 3 is a flowchart of an exemplary process for selecting third-party content for use in creating a biographical presentation using the system of FIG. 1;

FIG. 4 is a block diagram of an exemplary user interface for entry of biographical information into the system of FIG. 1; and

FIG. 5 is a block diagram of an exemplary user interface for reviewing content for use in a biographical presentation using the system of FIG. 1.

### DETAILED DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

The present disclosure relates generally to a system for creating a biographical presentation. The system preferably automatically retrieves content relevant to the subject of the biographical presentation based upon information provided by a user of the system. The system also preferably provides the opportunity for sponsored content relevant to the subject's life to be included in the presentation.

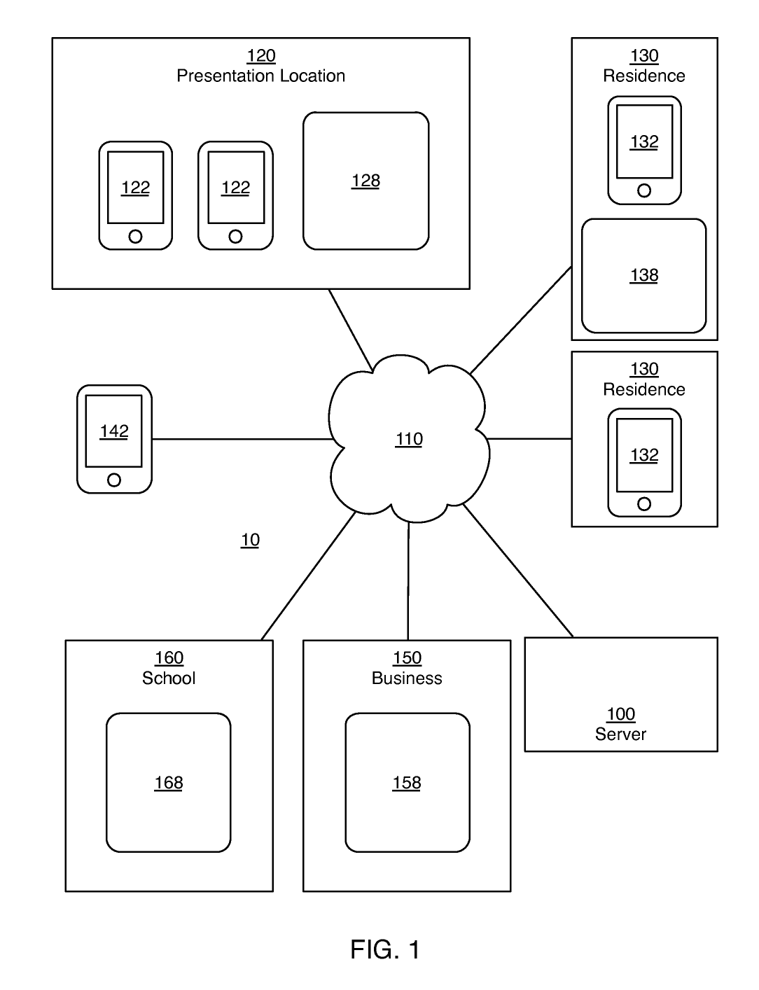

Referring to the drawings in detail, wherein like reference numerals indicate like elements throughout, FIG. 1 is a system diagram of a system 10 for creating biographical presentations. A server 100 provides centralized functions related to creation of biographical presentations. While the server 100 is shown as a single entity, it is to be understood that server 100 may be implemented by any combination of computing devices, including one or more physical or virtual servers.

The servers preferably implement an N-tier server infrastructure having one or more application servers, one or more web servers, and one or more database servers. The servers or server components may communicate with each other over a local area or wide area network, not shown, or, in some cases, a network 110, which may comprise portions of the Internet. The servers may be implemented using purpose-built or general purpose computing hardware, comprising processors for execution of program code for performing the processes described below, memory for storing program code and data, and interfaces for communications. Furthermore, any of the servers may utilize separate database servers for storage and retrieval of data, as well as other specialized servers or devices for other functions.

In one embodiment, the server 100 preferably incorporates a database to store biographical information for use in an algorithm that generates unique biographical presentations. In a preferred embodiment, the system acts as both as mechanism for entry and retrieval of biographical data. Remote management and communication functionality is utilized by the subject, relatives, friends, or service providers, to provide access to such functions.

Server 100 stores program code for presenting user interfaces for collecting biographical and other information for use in creating biographical presentations. In a preferred embodiment, server 100 stores audio, video, graphical, and textual resources for use in biographical presentations, as well as references to such content stored in other locations, particularly on other servers available via the Internet. Server 100 also stores program code for execution by one or more processors for combining these resources, responsive to collected information regarding the subject and selections made by a user, into a biographical presentation, as described further below. It is to be understood that in some cases, the user may also be the subject. It is to be further understood that while the processes may be described with respect to a single user, multiple users may participate in the creation of a single biographical presentation in some instances.

Mobile devices 122 and one or more computers 128 at a presentation location 120, such as a home, party hall, or funeral home, connect to the server 100 over network 110 to provide and retrieve data, including biographical data and resulting biographical presentations. A single server 100 may provide biographical presentation creation services to multiple presentation locations 120, and any number of mobile devices 122 and computers 128 may be utilized.

Additional mobile devices 132 or computers 128 may be utilized at residences 130 for submission of biographical data and receipt of communications from the server 100. Mobile device 142 may be used to upload information or to view or download biographical presentations from the server 100. Any of mobile devices 122, 132, and 142 may communicate with the server 100 via a variety of, and combination of, networks, including wired or wireless local area networks, wide-area networks, cellular networks, and the Internet.

Entities such as businesses 150 or schools 160 may also access server 100 using computers 158 and 168 to upload content for use in biographical presentations. Businesses 150 and 160 may also access server 100 using computers 158 and 168, for instance, to view placement statistics for uploaded presentation content, to modify the available content, or to view billing data related, for instance, to placement of content in biographical presentations.

It is to be understood that FIG. 1 is merely an exemplary figure of one deployment of the system. Different numbers of presentation locations 120, residences 130, businesses 150, schools 160, mobile devices 122, 132, and 142, computers 128, 138, 158, 168, and networks 110 may be utilized within the scope of the invention. Furthermore, computing devices may also be used in other locations by the subject, family, friends, colleagues, or service providers.

Biographical presentations for a subject may be created using the system 10 by the subject himself or herself, a family member, friend, or service provider. The user initiating creation of the biographical presentation may be required to accept a license agreement and set a password. The system 10 may provide the ability to configure access to editing and viewing of the biographical presentation to one or more other users. Additionally, access to only specific portions of the biographical presentation for editing or viewing may be provided to specific users or sets of users. The users may login via the web on a computer or tablet or download a mobile application for use with the system 10. In a preferred embodiment, applications are provided for the iOS and Android operating systems.

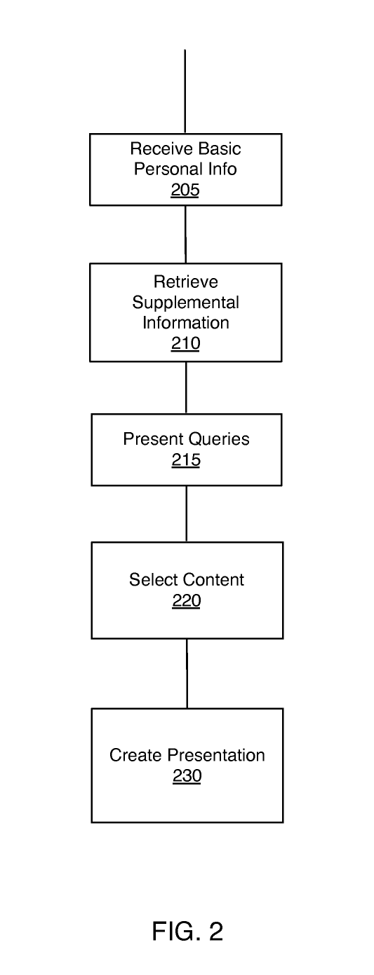

FIG. 2 is a flowchart of an exemplary high-level process for creating a biographical presentation using the system 10 of FIG. 1. The process may be executed in part or in total by server 100, in communication with a user's device and application.

At 205, general personal information regarding the subject of the biographical presentation is input by a user and received by server 100. Information may be entered at any of the computing devices or mobile devices described with respect to FIG. 1. After information has been entered, the user can preferably view a display of the entered information and edit the information as needed. The initial information entry will preferably include the subject's name and date of birth, and optionally, identities or credentials for various social media sites, which may contain additional information regarding the subject. In some embodiments, additional information regarding work history, education, favorite sports teams, favorite movies or music, hobbies, military service, vacation locations, residences, or key life events may also be collected at this stage.

At this or later stages, the user may also be prompted for existing digital or non-digital assets relevant to the subject's life. For instance, the user may be provided with the opportunity to upload photos, video files, audio files, or publications associated with the subject.

At 210, the system utilizes information collected or derived at 205 to retrieve supplemental information potentially relevant to the biographical presentation. The server 100 may, for instance, based upon the basic personal information received at 205, attempt to locate additional information from public or private databases, the Internet, or from social media sites to aid in populating the biographical presentation. For instance, the subject's work history may be derived from a professional social networking site. Information regarding the subject's personal associations may be derived from one or more personal social networking sites or by analyzing patterns and content in the subject's email accounts. Other information may be gathered by analyzing patterns in bank or other purchase transactions, such as an indication of a favorite restaurant, coffee shop, or store. In a preferred embodiment, the user will be given the opportunity to review and correct or verify the retrieved information.

At 215, the system causes the presentation of additional queries to the user to elicit more information about the subject and the type of information that should be included in the biographical presentation. These queries may be aimed at extracting additional detail regarding the subject's interests, family, career, or any other aspect of life.

In one embodiment, the server compares the date of birth of the subject with the times at which major historical events occurred. The user may be queried as to whether one or more of these events played a part in shaping the subject's life, or whether the subject participated in the event. For instance, if it was determined that the subject would have been in his or her twenties during World War II, the system may query the user as to whether the war had a particular impact on the subject's life, or whether the subject served in the military during the war. The answers to these queries may then be used at 220 below in the selection of content for inclusion in the biographical presentation, such as presentations on World War II, a particular battle, a particular military unit, or a particular theater.

In another embodiment, if the basic personal information indicated that the subject had been married, the system may, at 215 present queries regarding the location or timing of a wedding, a honeymoon, and the couples' first residence together. The answers to these queries may then be used at 220 below in further selection of content for inclusion in the biographical presentation, such as pictures or videos of the location of the wedding or honeymoon, preferably from a time close to the wedding.

In another embodiment, for instance, if information was gathered regarding a first car, further queries may be presented to obtain enough information that an accurate image of the vehicle the subject owned may be located at 220.

It is to be understood that certain items of personal information may be collected at various stages within the scope of the invention. For instance, information regarding siblings, schools, or social media accounts may be collected as primary information at 205 or collected via queries at 215.

It is to be understood that some or all of 215 may be performed before or concurrently with 205 or 210. In some cases, information retrieved from social media sites or other sources at 215 may cause the generation of additional queries at 210 and the process may iterate. In some embodiments, some of the required data may be acquired automatically from social media sites. For instance, sites like Facebook, LinkedIn, or Ancestry.com may be used to provide data regarding friends, colleagues, and relatives, respectively. Acquisition of social media account information may occur at 205 instead of 210, and queries at 210 may then be based in part on information gathered from social media accounts.

Information may also be gathered from the user to aid in the determination of appropriate music to accompany the presentation. In some embodiments, music from the period being highlighted at particular points in the presentation may be used.

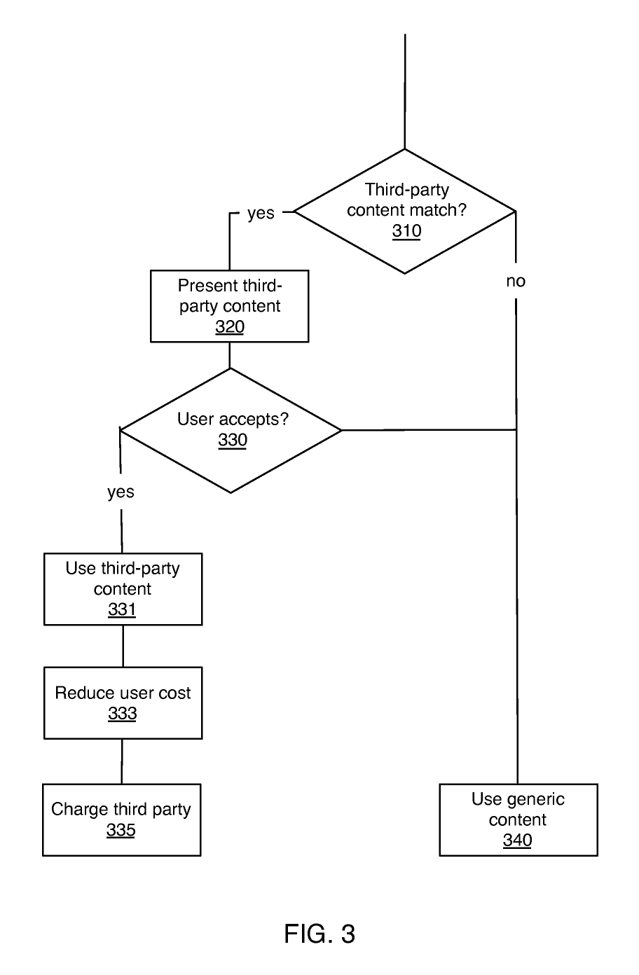

At 220, the system matches portions of the biographical data retrieved at 205, 210, and 215 with parameters associated with content elements available for inclusion in biographical presentations, including third-party content and sponsored content. As described above, content elements may include, but are not limited to, audio, video, graphical, and textual elements. An embodiment of a process for selecting third-party content for inclusion is described further below with respect to FIG. 3. It is to be understood that while the steps are shown in a particular order, the order of some steps may be changed, and steps may be combined.

It is to be understood that in addition to 205, 210, 215, and 220 being performable in other orders, they may also, in some instances, be performed in parallel. For instance, supplemental information retrieval 210 may begin while basic information gathering 205 is underway, and in some cases, may remove the need for some of the data entry for the user via automatic population of data fields for verification.

At 230, the biographical presentation is rendered. The presentation may be rendered, for instance, as a video file, a web page or a series of web pages, or a Microsoft Word document or Adobe PDF document. In an embodiment in which a video file is produced, textual biographical data specific to the subject may be overlaid over a series of relevant video clips. Video clips may comprise those uploaded by the user, those retrieved by the system based upon relevance to a portion of the biographical information, and those provided by third-parties and selected at 220. Content may be retrieved both locally from server 100 and from other locations. In some cases, photos or still imagery from each of those sources may be rendered as still or moving video. In an embodiment where a web presentation is being rendered, the system may produce one or more HTML files comprising links to audio and video content. Narration for the content may be generated programmatically and rendered using a computer-generated voice or recorded by a human narrator.

In an embodiment in which video is produced, the resulting video may be uploaded to a file-sharing, video-sharing, or social media site such as Dropbox, YouTube, or Facebook. The resulting video may also be exported to a portable storage device, such as a hard drive or memory stick, or to a disc format such as DVD or Blu-ray, for transport to the location of a celebration or a memorial.

In some cases, the user may be prompted to provide information to allow creation of full or partial biographical presentations for important people in the life of the primary subject. If the primary subject had an influential role in the lives of others, portions of biographical presentations of those people, particularly as they related to the influence of the primary subject, may be included in the primary subject's presentation. For instance, achievements of the subject's children may be highlighted in the subject's biographical presentation.

Generation of the biographical presentation may be made contingent upon the user providing payment. In some cases, the amount of the required payment may be reduced in exchange for inclusion of third-party content at 220. The system may require increased payment for longer videos or for inclusion of those premium elements that are not included in a base price, such as additional licensed video segments, licensed audio, or professional narration services.

FIG. 3 is a flowchart of an exemplary process for selecting third-party content for inclusion in the biographical presentation. The process may be performed, for instance, as a part of, or during one iteration of, 220 above. It is to be understood that the flowchart represents one possible ordering of steps and that order should not be construed as limiting. It is also to be understood that the steps may performed repeatedly for various pieces or combinations of biographical data.

At 310, a determination is made as to whether there is a third-party content match for a portion of the biographical data. For instance, if the biographical data indicates that the subject attended Duke University, the system 100 may check to see whether Duke University or a representative has provided content related to the university for use in biographical presentations. As another example, if the biographical data indicates a hometown of Toledo, Ohio, the system 100 may check to see whether official content regarding Toledo has been provided for use in biographical presentations, perhaps by the city or its Chamber of Commerce.

In a preferred embodiment, the determination at 310 is made as to whether third-party sponsored content, that is, content for which a third-party is willing to provide compensation for inclusion, is available. It is to be understood, however, that the compensation may or may not be the determining factor, and the compensation may be direct or indirect. For instance, compensation may reduce the cost of the biographical presentation to the user, or may be used to generally subsidize the service-providers operation without a direct link to the individual user's expenditure.

The determination at 310 may be made based upon a single piece of biographical data or a combination of two or more data elements. In some embodiments, multiple versions of third-party content may be provided for use depending upon other factors, such as years of attendance for content relating to a school, or date of birth for content relating to a hometown.

If, at 310, a determination is made that third-party content does exist that relates to a portion of the subject's biographical data, the user may be presented at 320 with a user interface allowing review of the proposed third-party content.

At 330, a determination is made as to whether the user has indicated acceptance of the proposed third-party content for inclusion in the biographical presentation. If at 330, the determination is made that the user did accept the proposed third-party content, the content is used, or tagged for use, in the biographical presentation at 331. In a preferred embodiment, at 333, the server 100 then reduces, or stores data to cause a reduction of, the cost of the biographical presentation in response to the user's inclusion of the third-party content. At 335, the server 100 charges, or stores data to cause a charging of, the third-party for the inclusion of the third-party content.

Again, it is to be understood that steps, particularly 331, 333, and 335, may be performed in various orders. In some embodiments, actual inclusion of third party content at 331 may be deferred until all decisions have been made, at which point all of the content is assembled during a single process. Additionally, in some embodiments, choices of third-party content may be provided related to a particular biographical element, in some cases with variable financial incentive for their inclusion. Creation of a biographical presentation may, in some cases, involve inclusion of content from multiple third-parties, resulting in multiple and possibly varying subsidization of the cost to the user. In some embodiments, some or all third-party content may be included without a user option.

In the event that a determination is made at 310 that no relevant third-party content is available for a particular portion of the biographical data, or in the event that third-party content is available but the user declines at 330, generic content will be used or generated at 340. The generic content may be derived, for instance, from a textual or animated representation of the biographical information, from stock photography or video, or from Internet content such as Wikipedia entries.

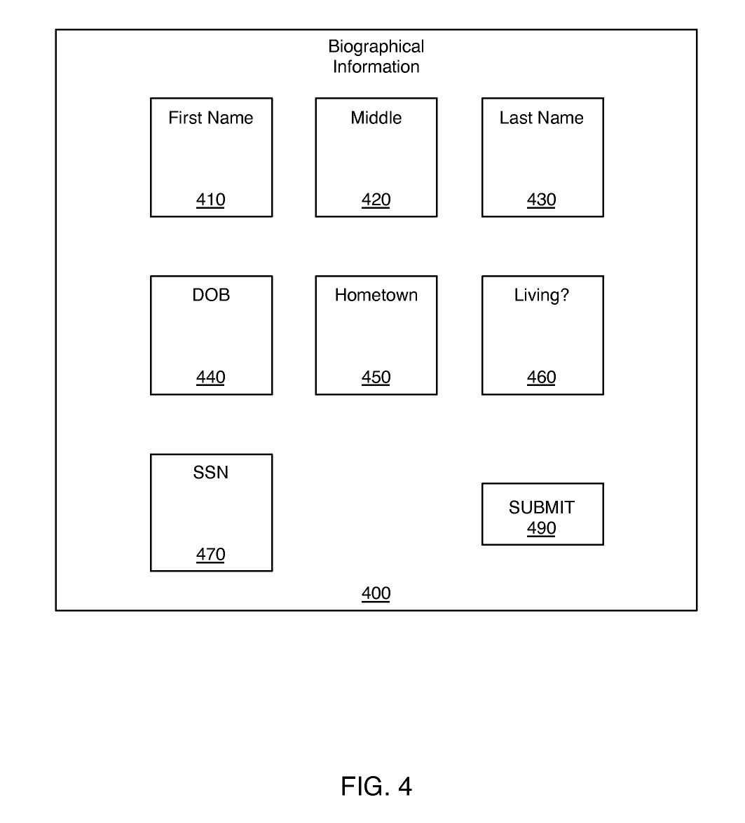

FIG. 4 is a block diagram of an exemplary user interface 400 for entry of biographical information. It is to be understood that the layout 400 shown in FIG. 4 is arbitrary and may be modified, including providing multiple screens for entry of individual data items or subsets of those items. It is also to be understood that the biographical data shown are examples related to a preferred embodiment of a system for creating a biographical presentation. The user interface 400 may be presented, for instance at 205 above.

The exemplary user interface 400 provides fields for entry of first name 410, middle name or initial 420, last name 430, date of birth 440, hometown 450, an indication as to whether the subject is living 460, and Social Security Number 470. A submission button 490 is provided for submission of the data after entry. The system preferably will disable submission button 490 until all required data have been entered, or present a warning dialog if submission is attempted before all required data has been entered. After entering the biographical data, the user may be prompted by the system to make sure that the data entered are correct before submission. If any parameter is out of an expected range the system will preferably trigger an alert to the user.

To increase the convenience of entering biographical data, and in turn, increase the completeness of the presentation, the system 10 preferably provides mobile applications for entry of data. In a preferred embodiment, applications are provided for the iOS and Android operating systems. The entry of information may be “crowd-sourced,” with numerous people provided portions of the biographical data with which they are familiar via web sites, mobile applications, email, or other data submission mechanisms.

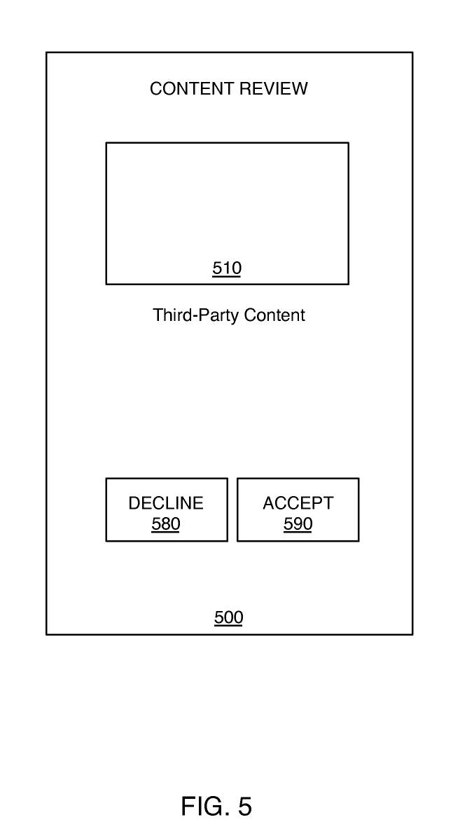

FIG. 5 is a block diagram of an exemplary user interface 500 for reviewing third-party content from the system 10 of FIG. 1. The user interface 500 may be presented on a computing device 128, 138, 158, or 168, or by a mobile application stored and executed on, for instance, mobile devices 122, 132, and 142, and may transmit data over network 110 to server 100. Such a user interface 500 may be presented, for instance, at steps 320 and 330 above.

As shown in user interface 500, a viewing window 510 for review of the third-party content is shown along with a button 580 for declining inclusion of the content and a button 590 for acceptance of the content for inclusion. The mobile application may then present a dialog for entry of the next piece of third-party content, or, after review of all matching content, submit the data to server 100. For instance, the mobile application may sequentially present dialogs for review of third-party content related to a hometown, a sports team, a military service, and a business.

The system 10 may also provide user interfaces for upload of third-party content. User interfaces may be presented by server 100, for instance as web pages, or by applications. The system 10 may require verification of affiliation with the third-party entity before making the uploaded content available for use in biographical presentations. The system may also prompt the third-party user for information regarding conditions under which particular pieces of uploaded content are relevant. For instance, a university may upload multiple video presentations, each focused on a particular decade or other timeframe in the school's history, such that a temporally relevant presentation may be selected for the subject of the biographical presentation. Similarly, a sports team may provide clips with highlights from various periods in the team's history such that highlights from relevant time periods may be selected by the system 10 or the user for inclusion in the biographical presentation.

The system may further provide an interface to allow the third-party to specify one or more financial incentives that it is willing to provide in exchange for the presentation being included in a biographical presentation. For instance, a university may offer a $1 payment for inclusion of a short segment or $5 for inclusion of an extended segment. The actual incentive provided to the user creating the biographical presentation may differ from the payment offered by the third party, particularly in cases where the operator of system 10 retains a portion of the payment.

The system may also utilize information regarding family trees to provide an interface for accessing biographical presentations of related parties. In a preferred embodiment, names or images of subjects are shown on the family tree and may be selected to initiate presentation of the associated biographical presentation.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A system for generating and presenting multimedia biographical content, the system comprising:
a memory for storing program code and data;
at least one interface for receiving and transmitting data;
a processor for executing program code from the memory for performing the steps of:
receiving first data associated with a first subject;
utilizing the first data associated with the first subject to retrieve second data associated with the first subject;
comparing at least a portion of the first data or the second data associated with the first subject with information regarding availability of supplemental content associated with an entity;
responsive to a determination that the at least a portion of the first data or the second data associated with the first subject corresponds to the information regarding availability of supplemental content associated with an entity, presenting a user interface element indicating the availability of the supplemental content associated with the entity for inclusion in the multimedia biographical presentation;
responsive to an indication from the user that the supplemental content associated with the entity should be included in the multimedia biographical presentation:
including at least a portion of the supplemental content in the biographical presentation; and
decreasing a cost associated with the multimedia biographical presentation.

2. The system of claim 1 wherein the entity is one of a school, college, business, professional, organization, club, military service, community, or sports team.

3. The system of claim 1 wherein utilizing the first data associated with the subject to retrieve second data associated with the subject comprises retrieving data from at least one of: a public database, a private database, the Internet, or a social media site.

4. The system of claim 1 wherein the first data comprises at least two of: name, date of birth, location of birth, Social Security number, identity of parents, and identities of family members.

5. The system of claim 1 further comprising: presenting queries based upon the first data associated with the subject or the second data associated with the subject to obtain third data associated with the subject.

6. The system of claim 1 further comprising: creating at least a portion of a second biographical presentation for a second subject; and including the at least a portion of the second biographical presentation in the first biographical presentation.
